(19) United States
(12) Patent Application Publication
(10) Pub. No.: US 2024/0427013 A1
(43) Pub. Date: Dec. 26, 2024

(54) PRESENCE DETECTING DEVICE

(71) Applicant: Elliptic Laboratories ASA, Oslo (NO)

(72) Inventor: Espen KLOVNING, Strømmen (NO)

(73) Assignee: Elliptic Laboratories ASA, Oslo (NO)

(21) Appl. No.: 18/692,406

(22) PCT Filed: Nov. 3, 2022
(86) PCT No.: PCT/EP2022/080720

§ 371 Date: Mar. 15, 2024

(30) Foreign Application Priority Data
Nov. 5, 2021 (NO) 20211335

(51) Int. Cl. G01S 15/04; G01S 15/00

(52) U.S. Cl. CPC G01S 15/04; G01S 15/003

(57) ABSTRACT

The present invention relates to a presence detecting electronic device as well as a method for using the device. The device including at least one microphone configured to receive acoustic signals from the environment, and a processor connected to the microphone for analyzing the received signal. The device also includes means for directly detecting the transmitted signal from an acoustic source and comparing the directly transmitted signal with the received signal for identifying if an object or user in the vicinity of the device based on the comparison between the transmitted and the reflected signal.

The present invention is based on the detection of a presence of a user or object, including the movements and gestures of the user.

Detecting the presence of a user to an electronic device is well known, e.g. as disclosed in U.S. Pat. No. 9,678,559 where a number of different sensors, including acoustic, vibration and visual sensors, are suggested to for detecting a user presence, where machine learning is used for recognizing activity close to the device. The solution is, however, vulnerable to noise and unexpected situations. In EP 2389598 a system is described where mobile phone or similar, possibly carried by a user, is configured to transmit a signal which may be detected. The described solution uses signals directly from the mobile phone and reflections in the room to detect the presence and position of the mobile phone. The monitored zone thus includes a number of passive acoustic receivers connected to the installation.

Active detection is also well known, for example including an ultrasound probe signal is sent out and when the ultrasound echos from objects in the detection zone are picked up by ultrasound receivers in the device, the signals are compared and analyzed to determine whether someone is present or not. This way the user is not required to carry a transmitter. There needs to be at least one ultrasound receiver and at least one ultrasound transmitter for this scheme to work. The ultrasound receiver and transmitter are in some cases combined in the same component capable of both transmitting and receiving the ultrasound signal at the same time. Such active presence detection is discussed at length in WO2021/045628 and NO20210304 as well as in simultaneously filed patent applications Ser. No. 20/211,332 and NO20211333 which are incorporated here by way of reference. The devices may be any electronic device such as computers, phones, TVs or tablets having a user interface that should be responsive to a user within an area close to the device.

The main issues for presence detection sensors based on ultrasound are interference, noisy environments, power consumption and intermodulation effects from playing audio concurrently on the same transmitting device. Another problem is related to the power consumption of the device using an active transmitter and receivers.

The present invention relates to an innovative approach to for achieving a presence detection while maintaining a low power consumption. This is obtained as specified in the accompanying claims.

The present invention is thus based on the concept using any audible or inaudible sound (e.g. infrasound, ultrasound) in the environment including output from any device that play out sound explicitly (e.g. radio, TV, smart speaker, hifi-system, smartphone, etc) or any object generating sound just by operating (e.g. coffee grinder, PC fan, dishwasher, etc). It is also possible to use sounds from living things (e.g. dogs, people, cats, etc) too including vocal sounds they emit or the noise they make moving around (e.g. creaking floor, bumping things, breaking things, playing, etc). The idea is that the presence detection device should use any detectable acoustic signal close to or within the detection zone of the presence detection sensor that can be picked up by at least one acoustic receiver.

The invention will be described more in detail below, referring to the enclosed drawing illustrating the invention by way of examples.

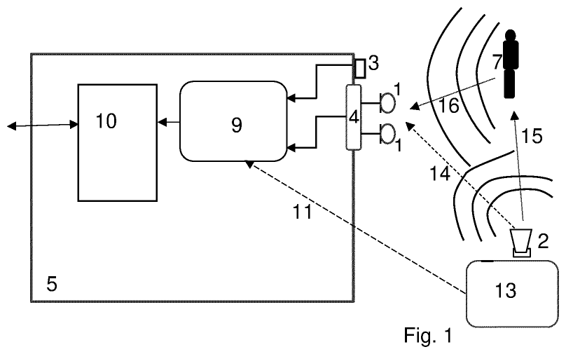

FIG. 1 illustrates the preferred embodiment of the invention.

As is illustrated in FIG. 1 the preferred embodiment of the device 5 includes at least two microphones 1 being connected through an interface 4 to a processor 9. The processor 9 is configured to analyze the frequency, phase and amplitude of the acoustic signal received by the microphones 1. The number of microphones may depend on the intended use and may be constituted by microphones implemented in the device for normal use or specially designed for the present purpose, and may be configured as a microphone array or matrix. The processor communicates the signal forward to the presence detection module 10 which can forward the presence indication signal, for example to activate the device or to external systems. The device 5 may be any type of device where the presence of a user may be of interest to the performance of the device, such as activating communication interfaces or screens in computers, mobile phones, game consoles, etc.

The present invention is based on the presence of at least one acoustic source 13 in the vicinity of the device, for example a radio 13 with a speaker 2 emitting a signal. The signal from the speaker will propagate through the space and be reflected by any person or object 7 in the area, and part of the reflection being received by the microphones. Even if there are other objects in the room the sound patter received by the microphones will change at the entrance of a user representing a change in the patterns and the analysis may define the change as a probable presence of a user 7. By comparing the previously measured patterns with the new pattern it is also possible to calculate the direction to the user or object. As part of the detection the processor may filter out certain frequency ranges, for example at high frequency and in the ultrasound range, where it is easier to distinguish features and objects in the room, and to calculate the presence in that range. The processing as such is related to room correction algorithms adjusting sound levels from measured controlled signals in a room.

The acoustic source may be of any kind generating a sound in the audible or ultrasound range. While a controlled signal may be preferable for accuracy the decision whether a person is present may allow more complex signals with less accuracy. According to one embodiment the signal is known or recognizable, for example music being recognized by the processor and making it possible to compare the recognized, stored music with the music detected by the microphones.

The acoustic receiver 1,9 could thus run all the time or be duty-cycled for power saving if necessary. The presence detection sensor could also use on-device, on-the-fly training to identify the primary user of the device through voice recognition. Identifying the main user to be within the detection zone could add additional information to the presence detection device. Due to the risk of spoofing, voice recognition should preferably not be used by itself to allow the user to enter the detection. If the detection zone is a security zone, using voice recognition to disable the presence detection alarm could be configurable by user or organization in charge of the protected space.

If the presence detection device is controlled by an access system, the voice recognition system should only do on-the-fly training to identify the main users of the device when the access system has not logged any intrusion event. Similarly, a HPD sensor on a laptop should only do on-the-fly training when the user is logged into the device when sitting in front of it talking while interacting with the device using at least one acceptable input method requiring proximity to the device (e.g. touch screen, keyboard, mouse, etc).

As mentioned above the presence device should preferably triangulate the position of available external sound sources continuously or in a duty-cycle manner if necessary. Alternatively, the presence detection device could use a probe signal (e.g. music, tone, speech, etc) emitted from a transmitter within its own device if available, or being coupled and synchronized with the device so as to reduce the necessary processing. In this case the transmitted signal from the speaker may be fed directly to the processor with a wired or wireless connection 11.

More in detail it is possible with the present invention to select the most suitable sound source from a set of available sound sources based on a set of relevant criteria such as amplitude, up-time, relative position, distance, identifiability, etc. The presence detection device should use these selected sound sources and the echos they create when bouncing off any user in the detection zone to identify if someone is present in the detection zone. The presence detection sensor will receive the direct path 14 signal from the sound sources 13 as well as the resulting echos 16 of the sound signals 15 reflected by the user 7 and use the received information 14,16 to find out if the user is present. For laptops with HPD sensors, the analysis of both the sound source echos bouncing off all parts of the user and the direct path sound from at least one sound source will find out if the user is in front of the laptop or not. The same principles apply to other presence detection devices with specified detection zones. The analysis will potentially include both advanced signal processing and serial or parallel execution of one or more neural network engines either executing in software or possibly accelerated in ML-optimized hardware engines.

As discussed above, triangulation of sound sources requires at least two acoustic receivers that are either separated to make triangulation possible if the physical layout of the receivers is known by the triangulation method. The frequency ranges discussed here is usually 0-384 KHz. Higher frequencies are also possible and will allow use of more bandwidth at the cost of memory, processing requirements and power consumption. There are other configurations of receivers that are ideal for triangulating sound sources, that is, receiver arrays. Since the distance between microphones in a microphone array is usually frequency dependent, the layout of the microphone array dictates the frequency range that can utilize the capabilities of a microphone array. Separating the acoustic receivers as much as possible is an advantage. Their position may also be important and should be selected with care. Adding additional acoustic receivers will in general improve the triangulation and thereby the presence detection solution.

If the device is in a space or room without any acoustic sound that can be utilized for presence detection in the target detection zone, the presence detection sensor may start using a probe signal either playing an audible signal (e.g. soothing music) or an ultrasound signal as discussed in WO2021/045628 and NO20210304, or by emitting audible sounds (e.g. music, video, audio, fan noise, etc), so that the presence detection solution can detect that and select an ideal part of the generated acoustic signal.

If the sound is emitted by at least one speaker in the device, the echo reference signal copy which is normally fed back into an echo cancellation module and could be forwarded to the presence detection module 10 providing information about the emitted signal. Comparing the echo reference signal to the received signal can be used to implement a presence detection solution based on echo analysis based on these to signals.

It should be noted that the phrase “presence detection” not only includes the verification of the user being present or not, but may also within the limitations of the available transducers, microphones and transmitted signals, also be configured to detect or recognize the nature of the detected object, e.g. by detecting the reflection characteristics compared to the transmitted sounds to detect whether or not the object is hard (possibly not a person), or soft, or by sampling a sequence measuring the speed or direction relative to the device. By analyzing the signal it may also be possible to recognize the posture of the user, e.g. leaning over the device or relaxing.

As mentioned above it may be advantageous to use a filter in the processing to select and use higher frequencies, preferably into the ultrasound range, to detect the presence, as it is well known that higher frequencies will increase the accuracy and resolution. Thus a detection system based on ultrasound or high frequency audible sound utilizing a set of high frequency transducers can be used to detect multiple objects close to the device.

For example, if an electronic device with at least one ultrasound output transducers sends out a broadband ultrasound signal (e.g. chirp, random modulation, frequency-stepped sines, etc), it can receive the ultrasound signal in at least one ultrasound input transducer and identify multiple objects in the targeted detection area. The different techniques to do this processing is known in the prior art as described in more detail in WO2017/137755, WO2009/122193, WO2009/115799 and WO2021/045628.

The resolution of the identified echos depends on bandwidth and frequency range of the signal. Higher sampling rates supported already by some consumer electronics (e.g. 96 KHz, 192 KHz, 384 KHz, etc) allows an increased signal bandwidth (e.g. more than 10 KHz) in a frequency range above the audible frequency range. With an increased signal frequency range and signal bandwidth, it is possible to identify multiple users (e.g. objects) and for each of them separate the different body parts such as fingers, hands, arms, head, torso, legs, etc. High frequency signals may also be affected by turbulence, e.g. cause by breathing, which means that variations in the received signal such as fluctuations in the signal phase, frequency and amplitude may be used to distinguish between a breathing person and an object.

In one embodiment of this invention, a laptop could send out a high-frequency, broadband signal to detect user presence. It could also detect user posture and breathing pattern while the user is sitting in front of the laptop whether he/she is interacting with it or not. The echo information could be combined with sensor data (e.g. hinge angle sensor, IMU sensor, light sensor, pressure sensor, ambient light sensor, etc) to provide more accurate information related to the detection. Identifying users peeking over the shoulder of the main laptop user is also possible with the increased resolution described here.

In another embodiment, a presence detection device could send out a high-frequency broadband signal to detect user presence. Since the resolution of the echos will be significantly higher and more details can be extracted, the presence detection device could monitor user movement and fed the data into an incremental, on-device ML-training process to create a continuously updated system such as deep neural network (DNN) that can be used to detect anomalies in user movement and gait.

To summarize the present invention is related to a presence detecting electronic device including at least one microphone configured to receive acoustic signals from the environment, and a processor connected to the microphone for analyzing the received signal. The device also includes means such as microphones and acoustic transducers and processors for directly detecting the transmitted signal from an acoustic source being positioned separate from the device and comparing the directly transmitted signal with the received signal for identifying if an object or user in the vicinity of the device based on the comparison between the directly transmitted signal and the signal reflected from the object or user. The device preferably includes at least two microphones, the processor being configured to detect the direction of the incoming signals, including the transmitted signal and the reflected signal.

According to one embodiment the acoustic source is independent of the device and the processor is configured to detect the direct acoustic signal as well as the first reflection and from the difference in time of arrival calculate whether a user is likely to be in the vicinity of the device.

The processor may be configured to detect the direction to the acoustic source and the direction of the reflected signal as well as the time difference between the signal arrivals at the detectors, and to analyze the likelihood of a user being present. Further analysis may be made from the received signals so as to analyse the nature of the assumed user, e.g reflectivity, hardness etc. The processor may also be configured to compare the time history of previous measurements to detect changes is the received signal possibly indicating the presence of a new object or user in the vicinity.

The processor may also be configured to filter the received acoustic signals at the microphones, the filter being a high pass filter selecting frequencies above a certain limit, such as 1 kHz, improving the accuracy of the distinction between the different acoustic propagation paths.

Instead of detecting the transmitted signals through the at least one microphone the processor may also be configured to directly receive the transmitted signal from a wireless or wired electronic connection for comparing with the received signal. In that case the wired or wireless connection is connected to the speaker or close to the speaker so as to compensate for any distortions caused by speaker protection processes or limitations in the signal processing and amplification.

The processor may be configured to recognize the transmitted acoustic signal by comparison with a databased including a set of samples, such as a streaming service, and to compare the received signals with the sample to analyze the received signal and detecting reflected signals in the received signals. In that case the processor may be configured to identify a user based on the distortions in the received signals compared with the original.

Depending on the processing capacity and microphone accuracy the processor may also be configured to analyze the characteristics of the received signals, such as amplitude and frequency range, so as to evaluate the size, position, posture or any gestures of the detected user.

The present invention also relates to a method for identifying a user in the vicinity of a device, after the transmission of an acoustic signal including the steps of:
receiving a first acoustic signal at a first time of arrival.
receiving a second acoustic signal representing a reflection of the transmitted acoustic signal at said at least one microphone at a second time of arrival,
based on the difference in time of arrival between the first and second arrival indicating if a reflecting object or person is within a predetermined distance from the device.

The device preferably includes two microphones, and thus the method includes a step of calculating the direction of at the reflected acoustic signal and providing an indication if the position of the user is within a predefined area relative to the device. If the transmitted signal is not directly connected to the processor the first received signal is received at the microphone.

1. A presence detecting electronic device comprising at least one microphone configured to receive acoustic signals from the environment, and a processor connected to the microphone for analyzing the received signal, wherein the device also includes means for directly detecting the transmitted signal from an acoustic source and comparing the directly transmitted signal with the received signal for identifying if an object or user in the vicinity of the device based on the comparison between the directly transmitted signal and the signal reflected from the object.

2. The presence detecting electronic device according to claim 1, wherein the device includes at least two microphones, the processor being configured to detect the direction of the incoming signals.

3. The presence detecting electronic device according to claim 1, wherein the acoustic source is independent of the device and the processor is configured to detect the direct acoustic signal as well as the first reflection and from the difference in time of arrival calculate whether a user is likely to be in the vicinity of the device.

4. The presence detecting electronic device according to claim 2, wherein the processor is configured to detect the direction to the acoustic source and the direction of the reflected signal as well as the time difference between the signal arrivals at the detectors, and to analyze the likelihood of a user being present.

5. The presence detecting electronic device according to claim 1, wherein the processor is also configured to filter the received acoustic signals at the microphones, the filter being a high pass filter selecting frequencies above a certain limit, improving the accuracy of the distinction between the different acoustic propagation paths.

6. The presence detecting electronic device according to claim 1, wherein the processor is configured to receive the transmitted signal from a wireless or wired electronic connection for comparing with the received signal.

7. The presence detecting electronic device according to claim 6, wherein the wired or wireless connection is connected to the speaker or close to the speaker so as to compensate for any distortions caused by speaker protection processes or limitations in the signal processing and amplification.

8. The presence detecting electronic device according to claim 1, wherein the processor is configured to recognize the transmitted acoustic signal by comparison with a databased including a set of samples, and to compare the received signals with the sample to analyze the received signal and detecting reflected signals in the received signals.

9. The presence detecting electronic device according to claim 8, wherein the samples are constituted by a music library, such as a streaming service, thus being capable of identifying a user based on the distortions in the received signals compared with the original.

10. The presence detecting electronic device according to claim 1, wherein the processor is configured to analyze the characteristics of the received signals, so as to evaluate the size, position, posture or any gestures of the detected user.

11. A method for identifying a user in the vicinity of a device, after the transmission of an acoustic signal, the method comprising:
receiving a first acoustic signal at a first time of arrival;
receiving a second acoustic signal representing a reflection of the transmitted acoustic signal at said at least one microphone at a second time of arrival; and
based on the difference in time of arrival between the first and second arrival, indicating if a reflecting object or person is within a predetermined distance from the device.

12. The method according to claim 11, wherein the device includes two microphones, comprising calculating the direction of at the reflected acoustic signal and providing an indication if the position of the user is within a predefined area relative to the device.

13. The method according to claim 11, wherein the first received signal is received at the microphone.

14. The method according to claim 11, wherein the transmitted signal has known characteristics, the second received signal being compared with the known characteristics for calculating of an object or user is in the vicinity of the device.

15. The presence detection electronic device of claim 5, wherein the certain limit is 1 kHz.

16. The presence detecting electronic device according to claim 10, wherein the characteristics are amplitude and frequency range.

17. The method according to claim 14, wherein the known characteristics are constituted by a sound or music store in a database.
